(19) United States
(12) Patent Application Publication
(10) Pub. No.: US 2011/0108351 A1
(43) Pub. Date: May 12, 2011

(54) GEAR UNIT FOR A COMPACT ALL TERRAIN VEHICLE

(76) Inventor: Christopher Gervais, Newnan, GA (US)

(21) Appl. No.: 12/616,285

(22) Filed: Nov. 11, 2009

(51) Int. Cl. B60K 17/00; F16H 57/10

(52) U.S. Cl. 180/337; 74/411.5

(57) ABSTRACT

A gear case 43 is provided, which houses an input shaft 52, intermediate shaft 55, output shaft 58 and brake discs 59 such that at least a portion of the intermediate shaft 55 and brake discs 59 overlap when viewed in the axial direction of the input shaft 52.

### 1. TECHNICAL FIELD

The present invention relates to a gear unit for vehicles which transmits motive force from a driving source, from an input shaft on which a wet brake is arranged, through bevel gears, to an output shaft.

### 2. BACKGROUND ART

A compact all-terrain four-wheel vehicle comprising a gear unit of this type is disclosed for instance in U.S. Pat. No. 6,805,217. A compact vehicle of this type is configured such that motive force from an engine is transmitted from an input shaft on which a wet brake is arranged, through a pair of bevel gears to an output shaft, and is transmitted from the output shaft to the rear wheels.

In the above conventional gear unit, the input shaft is coupled to the output shaft by a pair of bevel gears, so it becomes necessary to arrange the input shaft orthogonally, i.e. radially, with respect to the output shaft. Moreover, the location of the output shaft is determined by the location of the wheels. Therefore, with a conventional gear unit, it is not possible for instance to orient the input shaft horizontally so as to extend in the front-back direction of the vehicle, and arrange it at a position lower or higher than the output shaft. Therefore, the location of arrangement of the wet brake, which is arranged on the input shaft, is also determined by the location of the wheels, and of course the wet brake needs to be arranged while avoiding interference with surrounding components, so there is the problem that the degree of freedom of the wet brake layout is low.

### SUMMARY OF THE INVENTION

The present invention provides a gear unit for vehicles which makes it possible to increase the degree of freedom of layout of a wet brake.

The present invention is a gear unit for vehicles that includes: an input shaft connected to a driving source; an intermediate shaft to which motive force is transmitted from said input shaft via a first gear pair; an output shaft to which motive force is transmitted from the intermediate shaft via a second gear pair; a wet brake which has a plurality of brake discs and is provided on the input shaft; and a gear case which houses the input shaft, the intermediate shaft, the output shaft and the brake discs such that at least a portion of the intermediate shaft and the brake discs overlap when viewed from the axial direction of the input shaft.

In the gear unit according to one embodiment, an intermediate shaft is provided between the input shaft and output shaft, the input shaft and intermediate shaft are coupled via a first gear pair, and the intermediate shaft and output shaft are coupled via a second gear pair. Thus, there is no need to arrange the input shaft orthogonally to the output shaft, i.e. radially, and it is possible for instance to orient the input shaft horizontally so as to extend in the front-back direction of the vehicle, and to arrange it at a lower location or higher location than the output shaft. In this way, the present invention makes it possible to increase the degree of freedom of the arrangement location of the input shaft, and thus also the degree of freedom of the arrangement location of the wet brake.

Furthermore, in one embodiment, the input shaft, intermediate shaft, output shaft and brake discs are housed in the gear case such that at least a portion of the intermediate shaft and the brake discs overlap when viewed from the axial direction of the input shaft, allowing the gear unit as a whole to be made more compact while adding an intermediate shaft.

### BRIEF DESCRIPTION OF THE DRAWINGS

FIG. 1 is a front view of a vehicle comprising a gear unit according to an embodiment of the present invention.

FIG. 2 is a plan view of said vehicle.

FIG. 3 is a left side view of said vehicle.

FIG. 4 is a right side view of said vehicle in a state where the vehicle body cover and the front and rear fenders have been removed.

FIG. 5 is a plan view of said vehicle in a state where the vehicle body cover and the front and rear fenders have been removed.

FIG. 6 is a plan view showing the arrangement of said gear unit and a fuel tank.

FIG. 7 is a left side view showing the arrangement of said gear unit.

FIG. 8 is a right side view showing the arrangement of said gear unit.

FIG. 9 is a schematic cross-sectional plan view of said gear unit.

FIG. 10 is a schematic plan view of said gear unit.

FIG. 11 is a schematic right side view of said gear unit.

FIG. 12 is a schematic front view of said gear unit.

FIG. 13 is a left side view of said vehicle body frame.

FIG. 14 is a plan view of said vehicle body frame.

### DETAILED DESCRIPTION

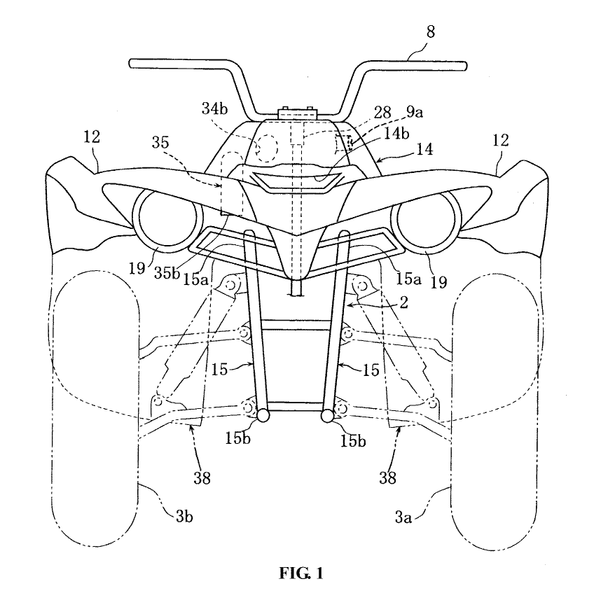

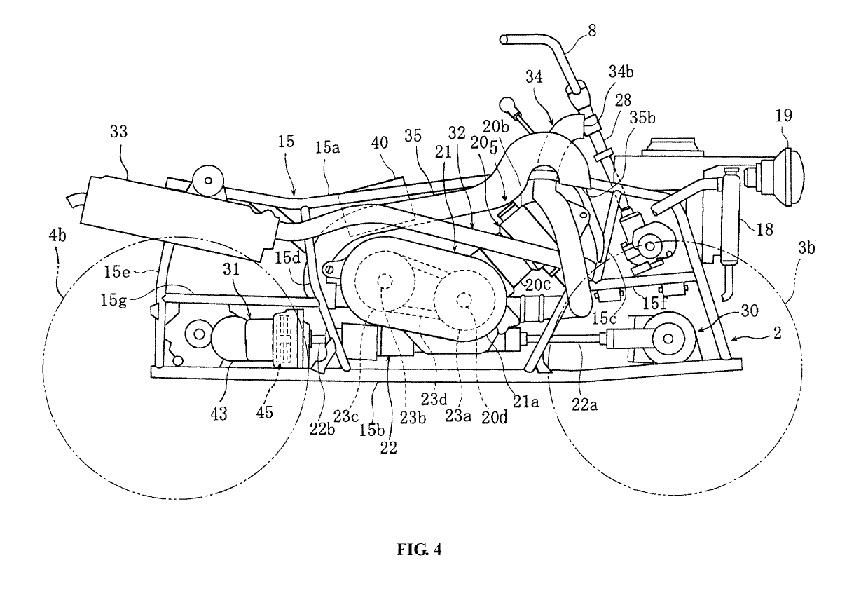

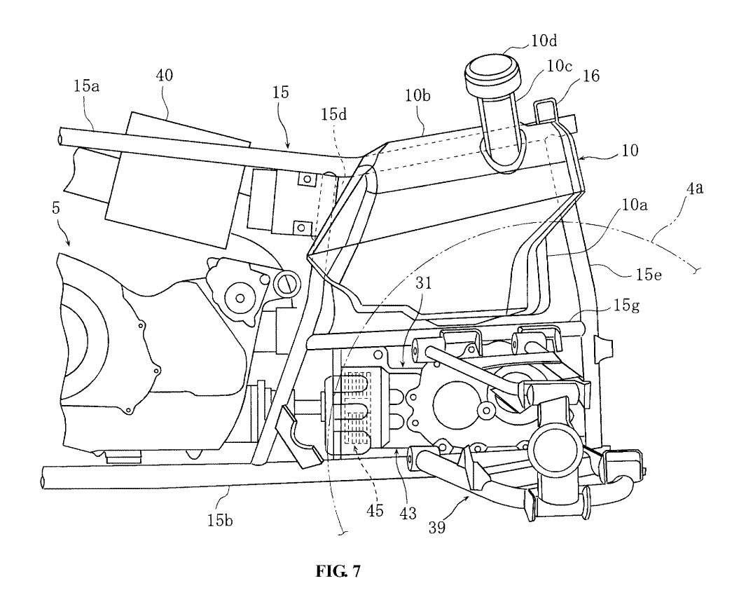

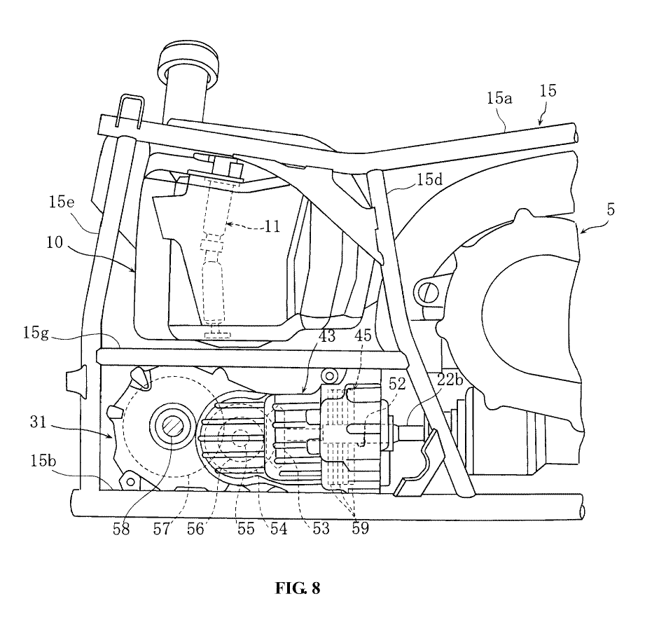

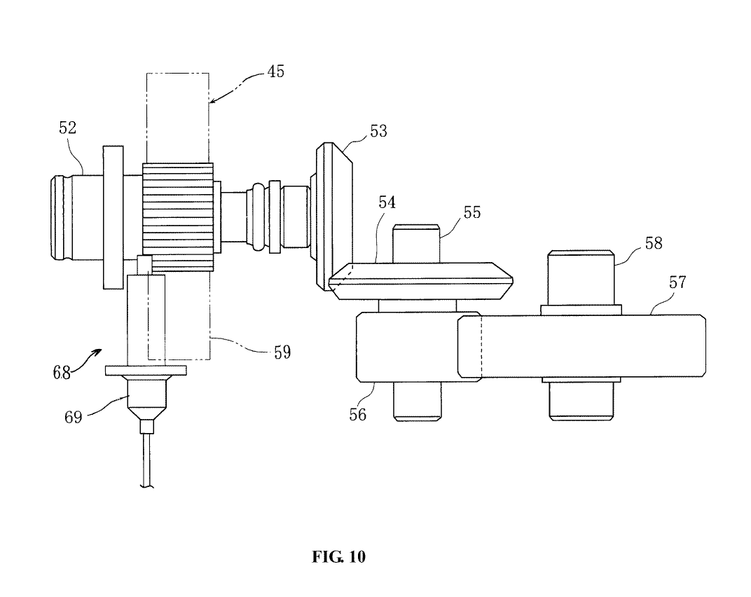

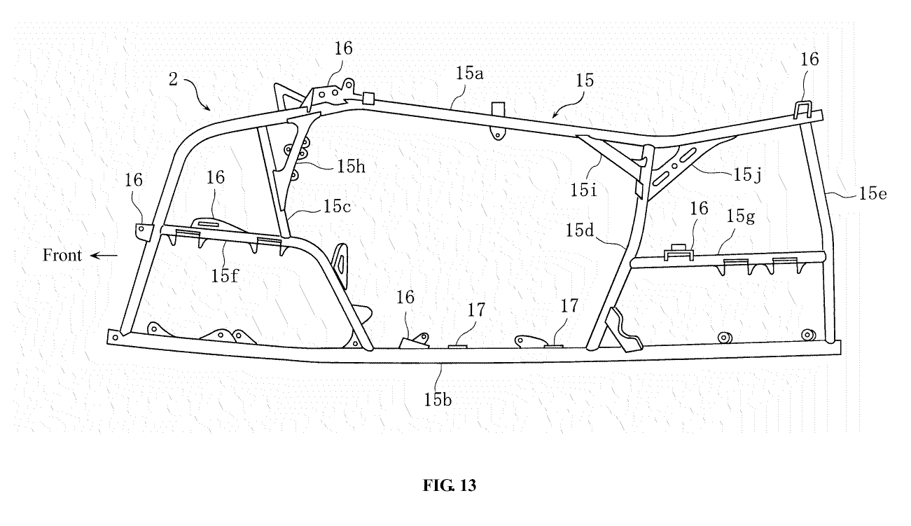

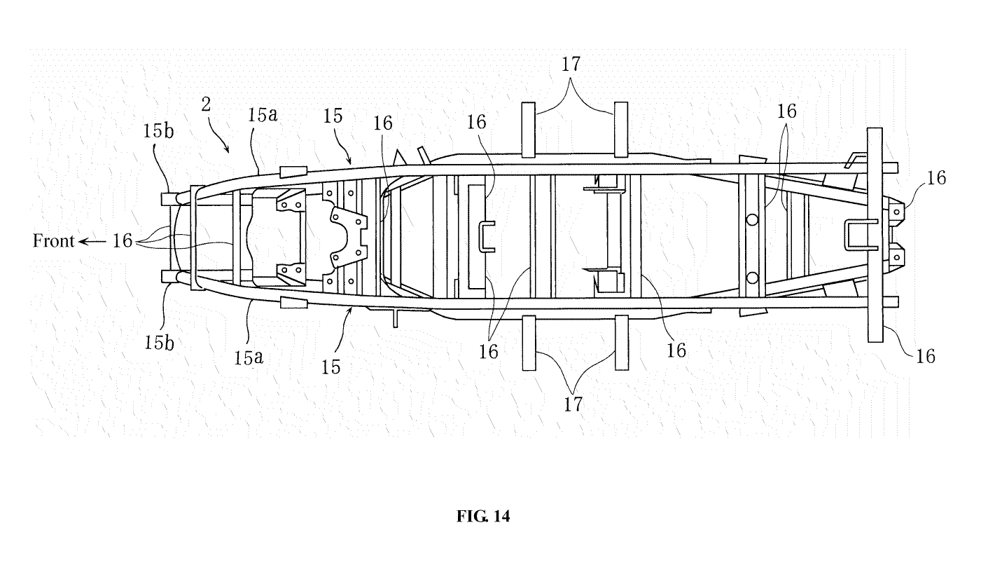

Embodiments of the present invention will be described below with reference to the drawings. FIGS. 1 through 14 are drawings illustrating a vehicle including a gear unit for vehicles according to an embodiment of the present invention. In the present specification, unless indicated otherwise, front, back, left and right signify the front, back, left and right as viewed while sitting on the seat.

In one embodiment, the compact all terrain vehicle 1 includes a vehicle body frame 2, a pair of left and right front wheels 3a, 3b arranged at the front of the vehicle body frame 2 and a pair of left and right rear wheels 4a, 4b arranged at the rear; an engine unit 5 mounted between the front wheels 3a, 3b and the rear wheels 4a, 4b on the vehicle body frame 2; a saddle seat 6 arranged so as to be located over the engine unit 5; and platform style footrests 7a, 7b arranged on the left and right sides of the engine unit 5 with respect to the widthwise direction of the vehicle.

Furthermore, the vehicle 1 includes a steering shaft 28 which is arranged on the vehicle body frame 2 further to the front of the vehicle than the seat 6, and steers the left and right front wheels 3a, 3b, and a handlebar member 8 mounted on the top end part of the steering shaft 28.

The vehicle 1 also includes an air cleaner 9 arranged on the vehicle body frame 2 between the seat 6 and the handlebar member 8, and a fuel tank 10 arranged on the vehicle body frame 2 between the left and right rear wheels 4a, 4b. A high pressure fuel pump 11 is furthermore provided inside the fuel tank 10.

The vehicle body frame 2 includes a pair of left and right steel tube frame members 15 extending in the front-back direction of the vehicle and multiple cross members 16 which extend in the widthwise direction of the vehicle and join the left and right frame members 15 to each other.

The left and right frame members 15 are substantially symmetrical between left and right. Each frame member 15 includes an upper frame 15a which extends in the front-back direction of the vehicle below the seat 6, and an underframe 15b which extends in the front-back direction of the vehicle below the engine unit 5. The front part of the upper frame 15a and underframe 15b is connected by a front suspension pipe 15f and front pipe 15c, and the rear part is connected by an intermediate pipe 15d and rear pipe 15e. The intermediate pipe 15d and rear pipe 15e are further connected by a rear suspension pipe 15g. 15h, 15i and 15j are reinforcing members.

A radiator 18 is arranged on the front part of the vehicle body frame 2, and a pair of left and right headlights 19 is arranged in front of the radiator 18. A storage box 41 is provided on the vehicle frame 2 under the seat 6, and a battery 40 is arranged inside the storage box 41.

The left and right front wheels 3a, 3b are supported so as to be vertically slidable on the vehicle body frame 2 by means of front suspensions 38. The left and right rear wheels 4a, 4b are supported so as to be vertically slidable on the vehicle body frame 2 by means of rear suspensions 39. In one embodiment, low pressure wide balloon tires are installed on the front wheels 3a, 3b and rear wheels 4a, 4b.

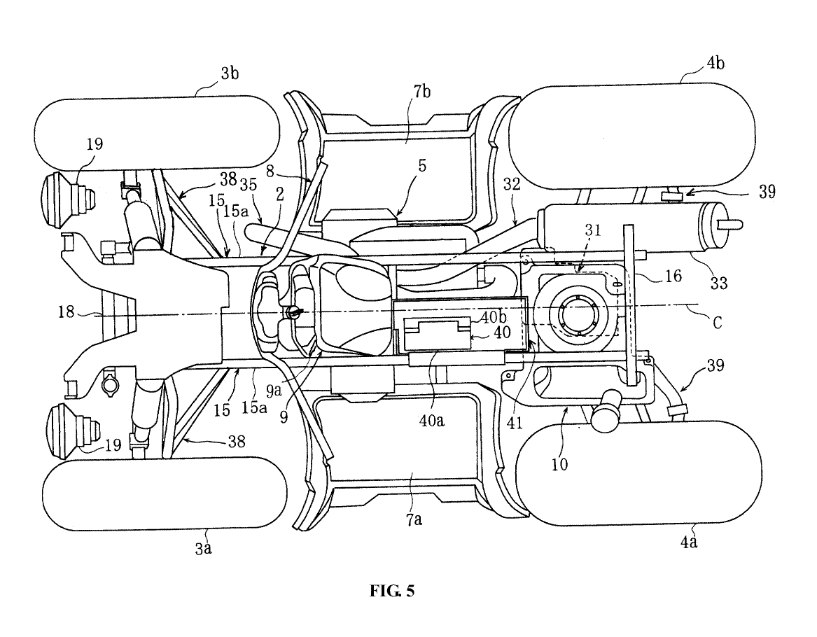

Left and right front fenders 12 which cover the left and right front wheels 3a, 3b and left and right rear fenders 13 which cover the left and right rear wheels 4a, 4b are attached to the vehicle body frame 2. Note that in FIG. 5, illustration of the left and right front fenders and left and right rear fenders has been omitted.

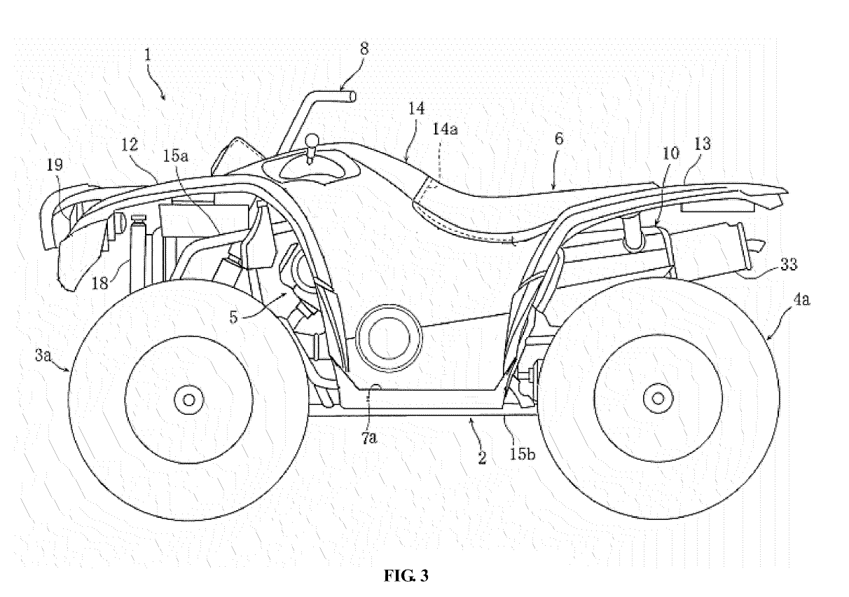

Furthermore, a vehicle body cover 14 which covers the area below and around the seat 6, as well as covering the air cleaner 9 and the space between the left and right front fenders 12, is attached to the vehicle body frame 2. A service opening 14a, which is opened and closed by the seat 6, is formed in the vehicle body cover 14 below the seat 6 (see FIG. 3).

In one embodiment, the engine unit 5 has a structure wherein a water cooled four cycle single cylinder type engine 20 and a V-belt type automatic transmission 21 are integrally connected, and the crankshaft 20d is mounted on the vehicle body frame 2 and is oriented in the widthwise direction of the vehicle and horizontally.

The engine 20 includes a crankcase 20a which houses a crankshaft 20d, a cylinder body 20c which extends diagonally forward and upward from the top front surface of the crankcase 20a, and a cylinder head 20b.

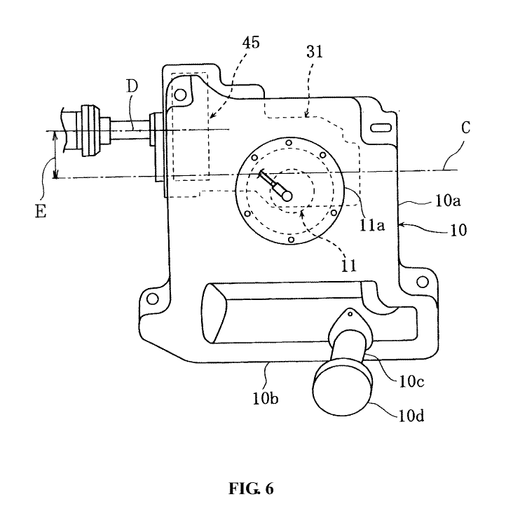

An air intake tube 25 is connected to the rear wall of the cylinder head 20b of the engine 20. The air intake tube 25 is arranged between the left and right frame members 15 and extends substantially vertically upward from the cylinder head 20b. A throttle body 26 is installed midway in the air intake tube 25, and the air cleaner 9 is connected to the upstream end (see FIG. 6).

A fuel injection valve 27 is installed in the throttle body 26. This fuel injection valve 27 injects and supplies high pressure fuel from a high pressure fuel pump 11 arranged inside the fuel tank 10 into the combustion chamber of the cylinder head 20b.

An exhaust pipe 32 is connected to the front wall of the cylinder head 20b of the engine 20. This exhaust pipe 32 is arranged so as to extend in the front-back direction of the vehicle in the area between the left and right frame members 15 and to the rear of the cylinder head 20b with respect to the front-back direction of the vehicle. More specifically, the exhaust pipe 32 is brought out from the cylinder head 20b toward the front of the vehicle, then passes along the right side of the cylinder head 20b, and extends toward the rear of the vehicle. A muffler 33 is connected to the downstream end of the exhaust pipe 32. Viewed from above, this muffler 33 is arranged between the right frame member 15 and the right rear wheel 4b.

The automatic transmission 21 is housed in a transmission case 21a connected to the right side wall of the crankcase 20a with respect to the widthwise direction of the vehicle. The automatic transmission 21 has a structure wherein a drive pulley 23a mounted on the crankshaft 20d and a follower pulley 23c connected to a follower shaft 23b are coupled by a V-belt 23d.

An air intake duct 34 which lets cooling air into the transmission case 21a, and an exhaust duct 35 which exhausts the cooling air which has flowed through the transmission case 21a, are connected to the transmission case 21a.

The air intake duct 34 is arranged so as to extend vertically along the right side of the cylinder head 20b with respect to the widthwise direction of the vehicle. The air intake port 34b formed on the top end part of the air intake duct 34 is arranged between the left and right upper frames 15a and further to the front of the vehicle than the steering shaft 28, and opens toward the front of the vehicle.

The exhaust duct 35 is arranged extending in the front-back direction of the vehicle between the left and right frame members 15 and above the engine unit 5. The exhaust port 35b formed in the front end part of the exhaust duct 35 is arranged to the right of the steering shaft 28 with respect to the widthwise direction of the vehicle, and opens toward the bottom of the vehicle.

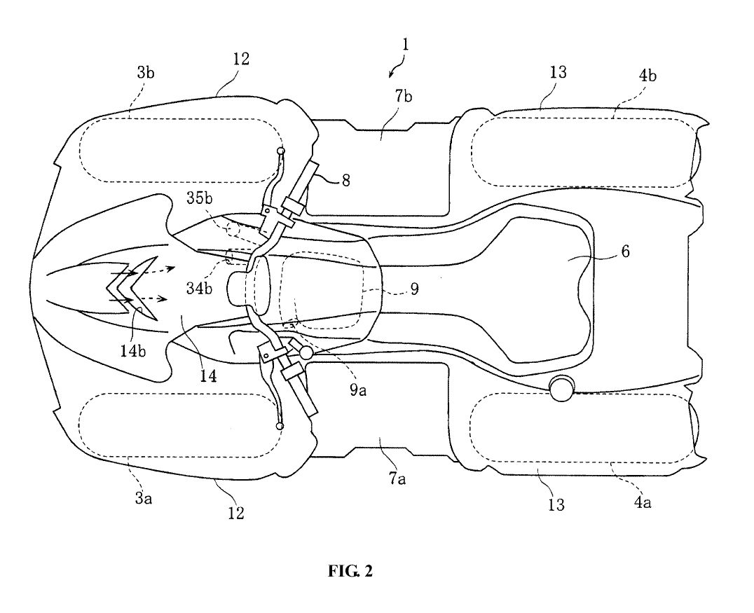

The vehicle body cover 14 covers the intake port 34b of the air intake duct 34, the exhaust port 35b of the exhaust duct 35, the area above the intake port 9a of the air cleaner 9, and the area around the steering shaft 28. A traveling air stream opening 14b which opens to the front of the vehicle is provided forward of the handlebar member 8 in the vehicle body cover 14 (see FIG. 1 and FIG. 2). A portion of the air stream generated by travel which is taken in through this traveling air stream opening 14b flows into the air intake duct 34 and air cleaner 9.

A front wheel drive shaft 22a extending toward the front of the vehicle and a rear wheel drive shaft 22b extending toward the rear of the vehicle are coupled to the follower shaft 23b of the automatic transmission 21 via a power transmission mechanism 22.

The front wheel drive shaft 22a is coupled to the left and right front wheels 3a, 3b by means of a front gear unit 30 and rotationally drives the front wheels 3a, 3b. Furthermore, the rear wheel drive shaft 22b is coupled to the left and right rear wheels 4a, 4b by a rear gear unit 31 and rotationally drives the rear wheels 4a, 4b.

The rear gear unit 31 is arranged between the left and right frame members 15 and below the fuel tank 10. Furthermore, the rear gear unit 31 is arranged such that the axis D of the input shaft 52 is offset by an amount E to the right with respect to the widthwise direction of the vehicle in relation to the centerline C passing through the center of the vehicle body frame 2 with respect to the widthwise direction of the vehicle (see FIG. 6).

The rear gear unit 31 includes the input shaft 52 connected to the rear wheel drive shaft 22b of the engine unit 5 (driving source), an intermediate shaft 55 to which the rotation of the input shaft 52 is transmitted via a pair of bevel gears (first gear pair) 53, 54, and an output shaft 58 to which the rotation of the intermediate shaft 55 is transmitted via a pair of spur gears (second gear pair) 56, 57. The input shaft 52, bevel gears 53, 54, intermediate shaft 55, spur gears 56, 57 and output shaft 58 are housed in gear case 43.

The input shaft 52 is arranged with its axis D oriented in the front-back direction of the vehicle and horizontally, and is rotatably supported on the gear case 43 by means of bearings 60, 61.

The intermediate shaft 55 is arranged rearward of the input shaft 52 with respect to the front-back direction of the vehicle and with its axis G orthogonal to the axis D of the input shaft 52. Furthermore, the intermediate shaft 55 is arranged with its axis G oriented in the widthwise direction of the vehicle and horizontally, and is rotatably supported on gear case 43 by means of bearings 62, 63.

The output shaft 58 is arranged rearward of the intermediate shaft 55 with respect to the front-back direction of the vehicle and parallel to the intermediate shaft 55, and is rotatably supported on gear case 43 by means of bearings 64, 65. Although not illustrated, the output shaft 58 is coupled to left and right rear wheels 4a, 4b by means of left and right universal joints and left and right drive shafts.

A wet brake 45 is provided on the input side part of the input shaft 52, and the bevel gear 53 is mounted on the rear end part so as to rotate together with the input shaft 52. Furthermore, a bevel gear 54 which engages with the aforementioned bevel gear 53 is mounted on one axial side of the intermediate shaft 55, and the spur gear 56 is mounted on the other axial side, so that both rotate together with the intermediate shaft 55.

The spur gear 56 mounted on the intermediate shaft 55 engages the spur gear 57 mounted on the output shaft 58, and faces the back surface of the bevel gear 54 mounted on the intermediate shaft 55.

The bevel gear 53 mounted on the input shaft 52 is configured to have a smaller radius than the bevel gear 54 mounted on the intermediate shaft 55, and the spur gear 56 mounted on the intermediate shaft 55 is configured to have a smaller radius than spur gear 57 mounted on the output shaft 58. As a result, rotation of the input shaft 52 undergoes speed reduction and is transmitted to the intermediate shaft 55 by the bevel gears 53, 54, and rotation of the intermediate shaft 55 undergoes speed reduction and is transmitted to the output shaft 58 by spur gears 56, 57.

The wet brake 45 includes brake discs 59 consisting of a plurality of stationary discs 59a and rotating discs 59b, and a pressure contact mechanism 68 which presses the discs 59a, 59b into contact in the axial direction, with the bottom part of the brake discs 59 being immersed into lubricating oil that is filled into the gear case 43.

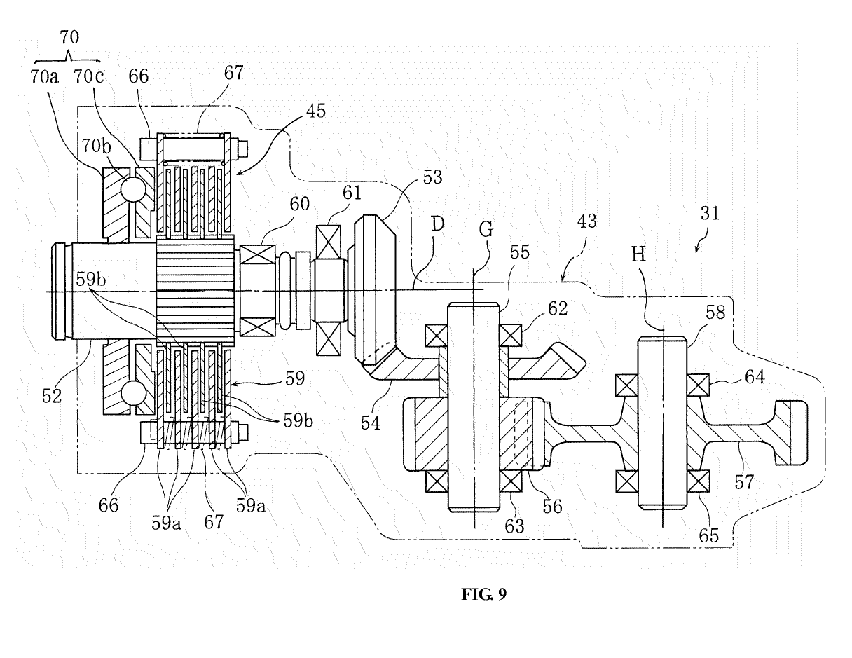

The stationary discs 59a, as shown in FIG. 9, are supported so as to be movable in the axial direction and non-rotatable by means of a plurality of pins 66 attached to the gear case 43. Furthermore, coil springs 67 which impel the stationary discs 59a away from each other are mounted on the pins 66. Furthermore, the rotating discs 59b are spline-fitted onto the input shaft 52 so as to be movable in the axial direction and to rotate together with the input shaft 52.

The pressure contact mechanism 68 comprises a cam member 70 mounted on the input shaft 52, and a plunger type driving member 69 which causes the cam member 70 to rotate about the shaft.

The cam member 70 comprises a cam plate 70a rotatably supported on the input shaft 52, and a pressure plate 70c which is arranged so as to face the cam plate 70a with a ball 70b therebetween, and to be movable in the axial direction.

The driving member 69 causes the cam plate 70a to rotate when a brake pedal (not illustrated) arranged near the footrest 7b is stepped on, causing hydraulic pressure to be generated in the master cylinder. Consequently, the cam plate 70a moves the pressure plate 70c in the axial direction, the stationary discs 59a and rotating discs 59b come into contact under pressure, and braking is applied to the rear wheels 4a, 4b as a result.

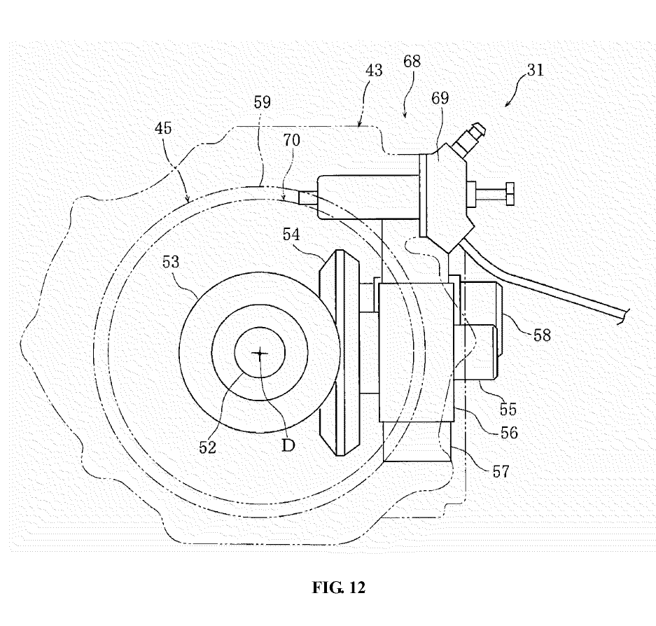

Here, viewed in the direction of axis D of the input shaft 52, the brake discs 59 are arranged so that an approximately ½ portion thereof with respect to the axial direction overlaps the intermediate shaft 55 and output shaft 58 (see FIG. 12).

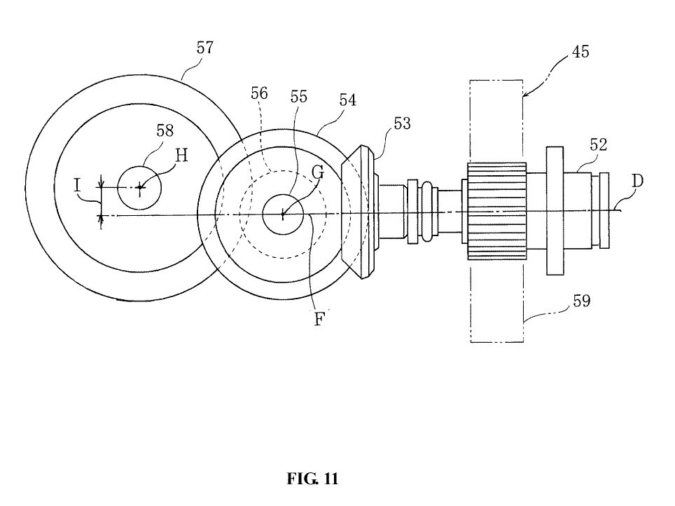

Furthermore, the input shaft 52, intermediate shaft 55 and output shaft 58 are arranged such that, when viewed in the direction of axis G of the intermediate shaft 55, the straight line F connecting said axis G and the axis D of the input shaft 52 runs below the axis H of the output shaft 58 by an amount I (see FIG. 11).

In one embodiment, an intermediate shaft 55 is provided between the input shaft 52 and the output shaft 58, the input shaft 52 and intermediate shaft 55 are coupled by means of a pair of bevel gears 53, 54, and the intermediate shaft 55 and output shaft 58 are coupled by means of a pair of spur gears 56, 57. Thus, there is no need to arrange the input shaft 52 orthogonally, i.e. radially, with respect to the output shaft 58, so it can be for instance oriented horizontally so as to extend in the front-back direction of the vehicle and arranged at a location lower in height that the output shaft 58 by an amount I (see FIG. 11). Of course, it is also possible to arrange the input shaft 52 at a location higher than the output shaft 58.

In this way, it is possible to increase the degree of freedom of the arrangement location of the input shaft 52, and thus the degree of freedom of the arrangement location of the wet brake 45.

Furthermore, as the height I increases, the relative location of the output shaft 58 will move closer to the input shaft 52, allowing the overall dimension of the rear gear unit 31 in the axial direction of the input shaft 52 to be made more compact.

Furthermore, in one embodiment, the input shaft 52, intermediate shaft 55, output shaft 58 and brake discs 59 are housed in the gear case 43 such that at least a portion of the intermediate shaft 55 and the brake discs 59 overlap when viewed in the direction of axis D of the input shaft 52, allowing the rear gear unit 31 as a whole to be configured more compactly while adding an intermediate shaft 55.

One embodiment is configured such that rotation of the input shaft 52 undergoes speed reduction and is transmitted to the intermediate shaft 55 by bevel gears 53, 54, and rotation of the intermediate shaft 55 undergoes speed reduction and is transmitted to the output shaft 58 by spur gears 56, 57, i.e. speed reduction is carried out in two stages, thus making it possible to achieve a large speed reduction ratio. Furthermore, since the wet brake 45 is provided on the input shaft 52, which has higher speed and thus lower torque, it becomes possible to obtain greater rear wheel braking power with a relatively small capacity wet brake 45 appropriate for a lower torque. If the wet brake were to be provided on the output shaft 58 which has lower speed and thus higher torque, a larger braking capacity appropriate for the larger torque would be necessary.

In one embodiment, the spur gear 56 arranged on the intermediate shaft 55 is provided at a location opposite the bevel gear 54 arranged on the intermediate shaft 55, allowing the axial length of the intermediate shaft 55 to be made shorter and thus allowing the dimension of the rear gear unit 31 with respect to the widthwise direction of the vehicle to be reduced.

Furthermore, coil springs 67 which impel the stationary discs 59a and the rotating discs 59b away from each other in the axial direction are provided, thus making it possible to reliably keep the stationary discs 59a and rotating discs 59b apart when not braking and to prevent brake drag.

While in the above embodiment, a case where the present invention was applied to the rear gear unit 31 was described, the present invention can also be applied to the front gear unit 30.

1. A gear unit for vehicle having a driving source comprising:
an input shaft connected to the driving source;
an intermediate shaft to which motive force is transmitted from said input shaft via a first gear pair;
an output shaft to which motive force is transmitted from said intermediate shaft via a second gear pair;
a wet brake which has a plurality of brake discs and is provided on said input shaft; and
wherein said input shaft is vertically offset from said output shaft providing flexibility in the positioning of said wet brake.

2. The gear unit of claim 1 including a gear case which houses said input shaft, said intermediate shaft, said output shaft and said brake discs such that at least a portion of said intermediate shaft and said brake discs overlap when viewed from the axial direction of the input shaft.

3. The gear unit of claim 2 wherein said wet brake comprises, in said gear case, said brake discs, which comprise a stationary disc arranged so as to be non-rotatable and axially movable and a rotating disc arranged on said input shaft so as to rotate with said input shaft and to be axially movable; and a pressure contact mechanism which causes said stationary disc and rotating disc to come into contact under pressure in the axial direction.

4. The gear unit of claim 3 further including impelling members which impel said stationary disc and rotating disc away from each other in the axial direction.

5. The gear unit of claim 1 wherein said first gear pair comprises a plurality of bevel gears with orthogonal axes of rotation and said second gear pair comprises a plurality of spur gears with parallel axes of rotation.

6. The gear unit of claim 5 wherein said spur gear of said second gear pair which is provided on the intermediate shaft is provided at a location opposite the back surface of the bevel gear of said first gear pair provided on the intermediate shaft.

7. The gear unit of claim 1 wherein said first gear pair is configured to perform speed reduction on the rotation of the input shaft and transmit that rotation to the intermediate shaft, and said second gear pair is configured to perform speed reduction on the rotation of the intermediate shaft and transmit that rotation to an output shaft.

8. A vehicle having a driving source comprising:
a vehicle body frame;
a pair of left and right front wheels supported on the front part of said vehicle body frame;
a pair of left and right rear wheels supported on the rear part of said vehicle body frame;
an input shaft connected to the driving source;
an intermediate shaft to which motive force is transmitted from said input shaft via a first gear pair;
an output shaft to which motive force is transmitted from said intermediate shaft via a second gear pair;
a wet brake which has a plurality of brake discs and is provided on said input shaft; and
said output shaft in operational communication with said left and right rear wheels for motivating said left and right rear wheels.

9. The vehicle of claim 8 wherein said input shaft is vertically offset from said output shaft providing flexibility in the positioning of said wet brake.

10. The vehicle of claim 8 including a gear case which houses said input shaft, said intermediate shaft, said output shaft and said brake discs such that at least a portion of said intermediate shaft and said brake discs overlap when viewed from the axial direction of the input shaft.

11. The vehicle of claim 10 wherein said brake discs which are arranged so that approximately ½ portion thereof overlaps said intermediate and output shafts.
